(19) United States
(12) Patent Application Publication
(10) Pub. No.: US 2025/0371678 A1
(43) Pub. Date: Dec. 4, 2025

(54) GENERATING ALIGNED IMAGES USING A DENOISING NEURAL NETWORK

(71) Applicant: Google LLC, Mountain View, CA (US)

(72) Inventors: Andrey Voynov, Tel Aviv (IL); Amir Hertz, Tel Aviv (IL); Shlomi Fruchter, Ness Ziona (IL); Daniel Cohen-Or, Hod Hasharon (IL)

(21) Appl. No.: 19/227,185

(22) Filed: Jun. 3, 2025

Related U.S. Application Data
(60) Provisional application No. 63/655,563, filed on Jun. 3, 2024.

(51) Int. Cl. G06T 5/60; G06T 5/70

(52) U.S. Cl. CPC G06T 5/60; G06T 5/70; G06T 2207/20081; G06T 2207/20084

(57) ABSTRACT

Methods, systems, and apparatuses, including computer programs encoded on computer storage media, for generating aligned output images. In particular, the described techniques include processing, for each target image of the output images and over a plurality of reverse diffusion steps, a respective first denoising input using a feature updating layer. The denoising input includes an input feature representation that in turn includes the feature representations of the target image and reference images. By processing the input feature representations of the target image and each of the reference images simultaneously using the feature updating layer, the system can ensure generation of style aligned output images.

### CROSS-REFERENCE TO RELATED APPLICATIONS

This application claims priority of U.S. Provisional Application No. 63/655,563, filed Jun. 3, 2024, the contents of which are incorporated herein by reference in their entirety.

### BACKGROUND

This specification relates to generating images using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a system implemented as computer programs on one or more computers in one or more locations that generates a set of aligned output images (i.e., a set of images that share a consistent style).

Particular embodiments of the subject matter described in this specification can be implemented so as to realize one or more of the following advantages.

The use of image generation neural networks (e.g., denoising neural networks) to generate images is pervasive across many technical fields. While image generation neural networks are capable of generating images that align with a provided style (through the use of conditioning inputs such as user provided natural language text, image(s), video(s), audio, and so on), generating a set of images that align with each other in addition to a provided intended style is challenging to accomplish in practice. That is, generating multiple images with a common style that do not individually retain unique stylistic characteristics is challenging. For example, an image generation neural network may be able to generate multiple images of “pixel art style” but the “pixel art style” among the generated images can be distinct from each other while still all being “pixel art style”.

In other words, denoising neural networks that generate images, e.g., conditioned on text prompts or on other conditioning inputs, have gained prominence across a variety of fields due to their ability to generate visually compelling outputs that accurately reflect the context provided by a given conditioning input. However, controlling these models to ensure consistent style remains challenging. That is, denoising neural networks will generally generate a visually compelling image from a given input but given the inherent stochasticity in the generation process, struggle to generate images with a style that is consistent across generated images and different conditioning inputs.

Even though it is challenging, the ability to generate such a set of style aligned images can be very important. As one example, generating a set of style aligned images can be used to generate a style-aligned data set for training a neural network that processes images. Training such a neural network with style-aligned data can facilitate the neural network to learn to disentangle content representation from style representation, which in turn can improve the neural network's performance generalization by allowing the neural network to focus on content features rather than style features.

Existing approaches to improving the consistency of the generated images necessitate fine-tuning of the denoising neural network, which can be computationally expensive, require manual intervention by users to modify their conditioning inputs-which can be difficult and burdensome for the user-or both, to disentangle content and style in images generated by the model.

To elaborate, one approach is to pre-train (i.e., train from randomly initialized trainable parameters) an image generation neural network to be able to generate a wide variety of image content, and then to fine-tune (i.e., further train from pre-trained trainable parameters) the image generation neural network on a set of images that share the same style.

Unfortunately, this approach is computationally expensive and usually requires human input in order to find a plausible subset of images (and also conditioning inputs) that enables the disentanglement of content and style.

This specification describes a system that can address the aforementioned challenges. That is, this specification describes techniques for generating a set of aligned output images, where the aligned output images include one or more reference images and a set of one or more target images. In particular, the described techniques include processing, for each target image of the output images and over a plurality of reverse diffusion steps, a respective first denoising input using a feature updating layer of a denoising neural network, to eventually generate the aligned output images. The denoising input includes an input feature representation that in turn includes the feature representations of the target image and the reference images. By processing the input feature representation which includes feature representations of both the target image and each of the reference images using the feature updating layer, the input feature representation can be updated not only using the input representation for the target image but also the feature representations for the one or more reference images. Thus, this method of updating can ensure the generation of consistent image sets (i.e., style aligned output images). Additionally, by incorporating the feature updating layers into previously trained denoising neural networks, the described techniques can generate consistent image sets without an optimization phase (i.e., training the denoising neural network from randomly initialized values for the trainable parameters) or a fine-tuning phase (further training the denoising neural network from pre-trained initialized values for the trainable parameters using several style consistent images).

In particular, it is because each reverse diffusion step for each target image accounts for the feature representations of the respective target image and reference image(s) through the use of the feature updating layer that the described techniques can generate style consistent image sets (i.e., aligned output images).

Additionally, it is because the described techniques can include one or more feature updating layers into a pre-trained denoising neural network which can already generate images that the described techniques can generate style consistent aligned output images without an optimization phase or a fine-tuning phase. That is, while traditional techniques require either an optimization phase or fine-tuning phase in order to be able to generate a set of aligned output images (which in turn require large computational memory use to store and load training data and potentially many compute hours, i.e., the use of many CPUs, GPUs, ASICs for thousands of hours, to update trainable parameter values), the describe techniques circumvent this computational cost entirely.

Moreover, because the described techniques do not require training or optimization, they can be easily combined with various image generation methods to generate style-consistent image sets. As some examples, the described techniques can be combined with ControlNet to generate style aligned images conditioned on depth maps, combined with MultiDiffusion to generate panorama images that share multiple styles, and combined with pre-trained personalized DreamBooth—LoRA models to generate aligned output images that are style consistent and include personalized content.

Furthermore, the described techniques provide means for control over the degree of style alignment of target image(s) to the reference image(s) by controlling the degree of feature updating (i.e., how many feature updating layers to include in a denoising neural network). Reducing the number of feature updating layers results in a more diverse image set, which still shares common attributes with the reference image. In general, the number of feature updating layers can be scaled up or down within the same denoising neural network, e.g., with replacing feature updating layers with self-attention layers, with replacing self-attention layers with feature updating layers, or with skip connections or otherwise circumventing some of the implemented layers. The same network can then generate aligned output images in which the degree of diversity in the aligned output image set can vary. In addition to increased granularity on the degree of image diversity, a denoising neural network as described herein can be implemented more efficiently because, instead of training and deploying a denoising neural network for every desired degree of image diversity, a single denoising neural network can be utilized, and therefore, fewer computational resources are required than would be otherwise.

Given the above, the described techniques of this specification enforce style alignment among a series of generated images in a computationally-efficient manner that does not require manual intervention. By employing minimal feature sharing during the reverse diffusion process, e.g., by making use of ‘attention sharing’ for one or more self-attention layers (i.e., processing input feature representation(s) for one or more feature updating layers) of the denoising neural network, the described techniques maintain style consistency across images. The described techniques can achieve these improvements without requiring any fine-tuning or manual intervention at generation time. As a particular example, this approach can allow for the creation of style-consistent images using a reference style through a straightforward inversion operation. The described techniques demonstrate high-quality synthesis and fidelity across diverse styles and text prompts, underscoring their efficacy in achieving consistent style across various inputs.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 shows an image generation system, according to aspects of the disclosure.

FIG. 2 is a flow diagram of an example process for generating aligned output images, according to aspects of the disclosure.

FIG. 3 is a flow diagram of an example process for processing the first denoising input for a reverse diffusion step, according to aspects of the disclosure.

FIG. 4 is a flow diagram of an example process for updating at least a portion of an input feature representation using a feature updating layer, according to aspects of the disclosure.

FIG. 5 shows an example feature updating layer, according to aspects of the disclosure.

FIG. 6 is an example of the performance of the described techniques.

FIG. 7 is an example of the generated aligned output images of the described techniques.

FIG. 8 is an example of the generated aligned output images of the described techniques.

### DETAILED DESCRIPTION

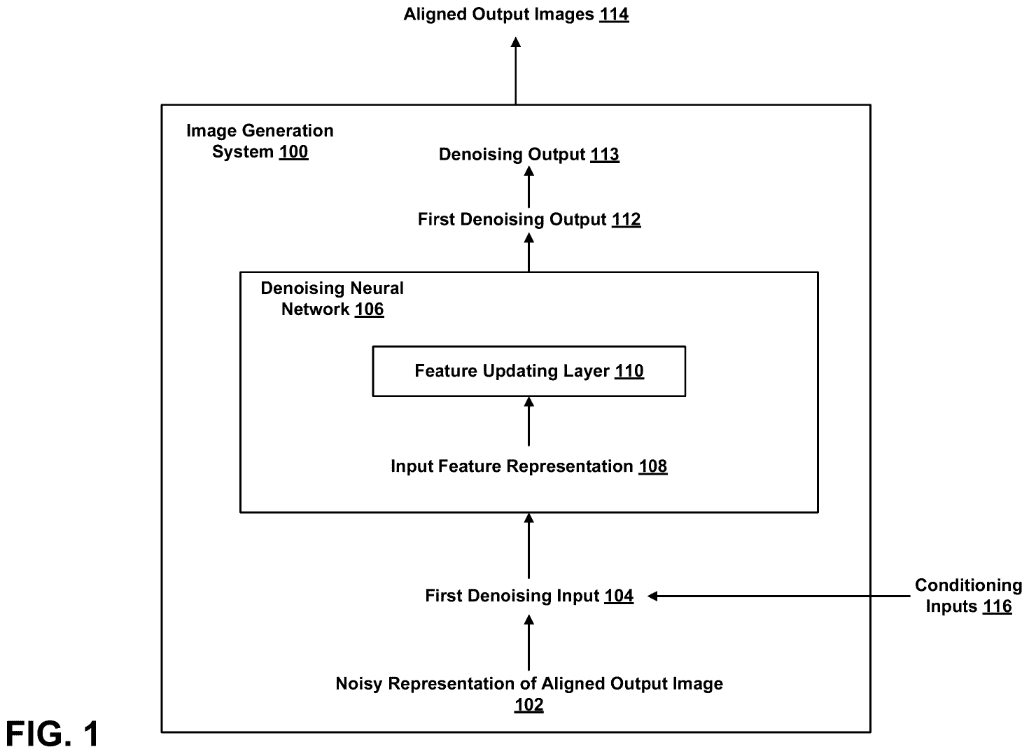

FIG. 1 shows an example image generation system 100. The system 100 is an example of a system implemented as computer programs on one or more computers in one or more locations, in which the systems, components, and techniques described below can be implemented. In particular, the system 100 generates a set of aligned output images 114.

The aligned output images 114 include a set of one or more reference images and a set of one or more target images, and the aligned output images 114 are referred to as “aligned” because, although the images 114 generally depict different content, the aligned output images 114 have a consistent style that is shared across all of the output images 114. For example, one of the images in the set can be designated as a “reference” image and all of the other images in the set (designated as “target” images) and can be generated in a manner that causes the style of the other images to be consistent with the style of the reference image, even if the content depicted in each of the other images are different. Therefore, the reference image(s) generally collectively define the “style” for which the target image(s) will incorporate such that the aligned output images 114 are style-consistent images and are therefore “aligned”. A style can include any type of shared characteristic across a set of images, for example: a common art style, e.g., pop art, pixel art, watercolor; a common perspective, e.g., landscape, portrait, etc.; a common color scheme, e.g., monochromatic, black & white, etc.; and so on.

More specifically, the system 100 generates the set of aligned output images 114 using a denoising neural network 106 that iteratively denoises a respective noisy representation 102 of each of the output images 114. In some examples, the denoising neural network 106 receives a respective conditioning input 116 to use when denoising the corresponding noisy representation 102 of an aligned output image. Examples of such denoising neural networks include Imagen, simple diffusion, and so on, and generally, the denoising neural network 106 can perform the denoising process in a latent-space or in the pixel-space of the generated images.

Each respective noisy representation 102 of each of the aligned output images 114 are “noisy representations” in that they are intermediate forms of the aligned output images 114 (e.g., intermediate noisy images in pixel space or intermediate noisy latent representations in latent space). When initialized, each respective noisy representation 102 of each of the aligned output images 114 has no information of the aligned output images 114 and the system 100 gradually denoises each respective noisy representation 102 of each of the aligned output images 114 to generate the aligned output images 114.

The denoising neural network 106 can generally be any denoising neural network that includes a feature updating layer 110 that is configured to receive an input feature representation 108 and to update at least a portion of the input feature representation 108. One example of such a layer is a self-attention layer.

More specifically, the denoising neural network 106 can generally be any appropriate denoising neural network. In some cases, the denoising neural network 106 is a conditional denoising neural network, meaning the denoising neural network is configured to process conditioning inputs 116.

In particular, at any given update iteration, the denoising neural network 106 is configured to receive, for each of the aligned output images 114, a first denoising input 104 that includes a noisy representation 102 of the aligned output image and, in some cases, a representation of a conditioning input 116, to process the first denoising input 104 to generate a first denoising output 112 which the system 100 uses to generate a denoising output 113 for the update iteration. Generally, the first denoising input 104 also includes a timestep that defines a noise level. For example, each update iteration can have a different noise level, e.g., as determined by a noise schedule. As will be described below, the conditioning input 116, when used, can be any appropriate conditioning input, e.g., a text prompt, another image, an audio signal, and so on, and generally is characterized by one or more properties to be included in respective output image. For example, a conditioning input that is natural language text such as “a toy airplane” can result in the system generating an output image that contains the object “a toy airplane”.

In some implementations, the denoising neural network 106 performs the reverse diffusion process in pixel space, so that the representations operated on and generated by the denoising neural network 106 are images that have values for each pixel that specify color values, e.g., RGB values or another color encoding scheme.

In these implementations, the denoising output 113 can generally be any appropriate output that defines a predicted noise component of the current noisy representation, i.e., the noise that has been added to the target image to generate the current noisy representation. For example, the denoising output 113 can be (i) an estimate of the target image (given the current noisy representation), (ii) an estimate of the noise that has been added to the target image to arrive at the current noisy representation, (iii) a v-parameterization of the target image and the noise, or (iv) another appropriate type of denoising output.

In some implementations, the denoising neural network 106 performs the reverse diffusion process in latent space, e.g., in a latent space that is lower-dimensional than the pixel space. In these implementations, the denoising output 113 can generally be any appropriate output that defines a predicted noise component of the current noisy representation, i.e., the noise that has been added to a representation of the target image in the latent space to generate the current noisy representation. For example, the denoising output 113 can be (i) an estimate of the final latent representation of the target image (given the current noisy representation), (ii) an estimate of the noise that has been added to the final latent representation of the target image to arrive at the current noisy representation, (iii) a v-parameterization of the final latent representation of the target image and the noise, or (iv) another appropriate type of denoising output.

In these implementations, the denoising neural network 106 can be associated with an image encoder to encode images into the latent space and a decoder neural network that receives an input that includes a latent representation of an image and decodes the latent representation to reconstruct the image. For example, the encoder and decoder can be trained jointly on an image reconstruction objective, e.g., a VAE objective, a VQ-GAN objective, or a VQ-VAE objective.

Thus, in these examples, after the reverse diffusion steps have been completed, the system 100 can use the decoder neural network to generate each of the aligned output images 114 from their respective representations in the latent space that has been generated using the denoising neural network 106.

The denoising neural network 106 can generally have any appropriate neural network architecture that includes a feature updating layer, as described herein.

For example, the denoising neural network 106 can be a convolutional neural network, e.g., a U-Net that has multiple convolutional layer blocks. In some examples, the denoising neural network 106 can include one or more cross-attention layer blocks interspersed among the convolutional layer blocks. As will be described below, some or all of the cross-attention blocks can be conditioned on a representation of the conditioning input 116. Additionally, the denoising neural network 106 can also include one or more self-attention layers that apply self-attention over a feature representation of the first denoising input 104. Examples of such architectures include the U-ViT architecture.

As another example, the denoising neural network 106 can be a Transformer neural network that processes the first denoising input 104 through a set of self-attention layers to generate the first denoising output 112. In these examples, the denoising neural network 106 can also include one or more attention blocks that are conditioned on a representation of the conditioning input 116.

To generate the aligned output images 114, the system 100 initializes a respective noisy representation 102 of each of the aligned output images 114. For example, the system 100 can sample each value in each noisy representation 102 from a noise distribution, e.g., a Gaussian distribution.

The system 100 then updates each respective noisy representation 102 of each of the aligned output images 114 at each of a plurality of reverse diffusion steps using the denoising neural network 106.

As part of the updating at any given step, the system 100 generates, for each respective noisy representation 102, a respective denoising output 113 for the reverse diffusion step.

The system 100 then updates the respective noisy representation 102 using the respective denoising output 113 for the reverse diffusion step.

For example, the system 100 can map the denoising output 113 to an initial updated representation and then apply a diffusion sampler, e.g., the DDPM (Denoising Diffusion Probabilistic Model) sampler, the DDIM (Denoising Diffusion Implicit Model) sampler or another appropriate sampler, to the initial updated representation to generate an updated noisy representation.

Optionally, after the last reverse diffusion iteration, the system 100 can refrain from using the diffusion sampler and can instead use the initial updated representation as the updated noisy representation.

To generate the denoising output 113, the system 100 processes a first denoising input 104 for the reverse diffusion step that includes the respective noisy representation 102 of the aligned output image using the denoising neural network 106 to generate a first denoising output 112. In some cases, the first denoising output 112 is the denoising output 113. In other cases, the system 100 uses the first denoising output 112 to generate the denoising output 113 (e.g., the system can combine the first denoising output 112 with additional denoising output(s), e.g., that the system 100 generated also using at least the first denoising input 104, to generate the denoising output 113).

The system 100, in some cases, uses classifier-free guidance at each reverse diffusion step. When using classifier-free guidance, the system 100 processes the first denoising input 104 for the reverse diffusion step using the denoising neural network 106 but not conditioned on the respective conditioning input 116 to generate another denoising output. The system 100 then combines the conditional and unconditional denoising outputs in accordance with a guidance weight for the reverse diffusion step to generate a final denoising output.

The set of aligned output images 114 generated by the system 100 includes a set of one or more reference images and a set of one or more target images. As a particular example, the system 100 can designate one of the aligned output images 114 as a reference image, e.g., randomly or based on a position of the output image in a batch index or in response to a user input identifying which image should be the reference image, and then designate the remainder of the output images 114 as target images.

As part of the processing, to generate the output of the feature updating layer 110 for any given target image, the system 100 obtains a feature representation of the first denoising input 104 for the target image. For example, the feature representation can be the output of the layer preceding the feature updating layer within the denoising neural network 106 when processing the first denoising input 104 for the target image.

The system 100 also obtains a respective feature representation of the respective first denoising input 104 for each of the reference images, e.g., the output of the layer preceding the feature updating layer 110 within the denoising neural network 106 when processing the first denoising input 104 for the reference image.

The system 100 processes an input feature representation 108 that includes (i) the feature representation of the first denoising input 104 for the target image and (ii) the respective feature representation of the respective first denoising input 104 for each of the reference images using the feature updating layer 110 to update the feature representation of the first denoising input 104 for the target image. Thus, for each target image, the feature representation 108 is updated not only using the input representation for the target image but also the feature representations for the one or more reference images. This can ensure that the generated aligned output images 114 have a consistent style.

In some cases, to generate the output of the feature updating layer 110 for any given reference image, the system 100 obtains a feature representation of the first denoising input 104 for the reference image. For example, the feature representation can be the output of the layer preceding the feature updating layer within the denoising neural network 106 when processing the first denoising input 104 for the reference image.

In these cases, the system 100 processes an input feature representation 108 that includes the feature representation of the first denoising input 104 for the reference image through the feature updating layer 110 to update the feature representation of the first denoising input 104 for the reference image. Therefore, in some cases, the system 100 processes the feature representation of the first denoising input 104 for the reference image independently of the feature representation of the first denoising input for any of the target images.

In some cases, as part of the processing of the first denoising input 104 for the reverse diffusion step, for the feature updating layer 110 and for each target image, the input feature representation 108 for the feature updating layer does not include feature representations of the first denoising inputs for any of the other target images.

In some cases, the first denoising output 112 is the denoising output 113. In some other cases, the system 100 also generates one or more additional denoising outputs and then combines the additional denoising output(s) with the first denoising output 112 through classifier free guidance, i.e., by computing a weighted sum of the denoising outputs with the weight for each denoising output being determined by a guidance weight for the classifier free guidance.

After updating each respective noisy representation 102 for each of the aligned output images 114 at each of the plurality of reverse diffusion steps, the system 100 generates the aligned output images 114 from each respective updated representation of each of the aligned output images 114.

In some implementations, when each noisy representation 102 of the aligned output images 114 are in pixel space, the system 100 outputs, as the aligned output images 114, the updated noisy representations of the aligned output images after being updated at each of the plurality of reverse diffusion steps. In other words, the system outputs as the aligned output images 114 the most recently updated noisy representations of the aligned output images.

In some implementations, when each representation 102 of the aligned output images 114 are in latent space, the system 100 outputs, as the aligned output images 114, the decoded noisy representations of the aligned output images (using a decoder neural network) after being updated at each of the plurality of reverse diffusion steps.

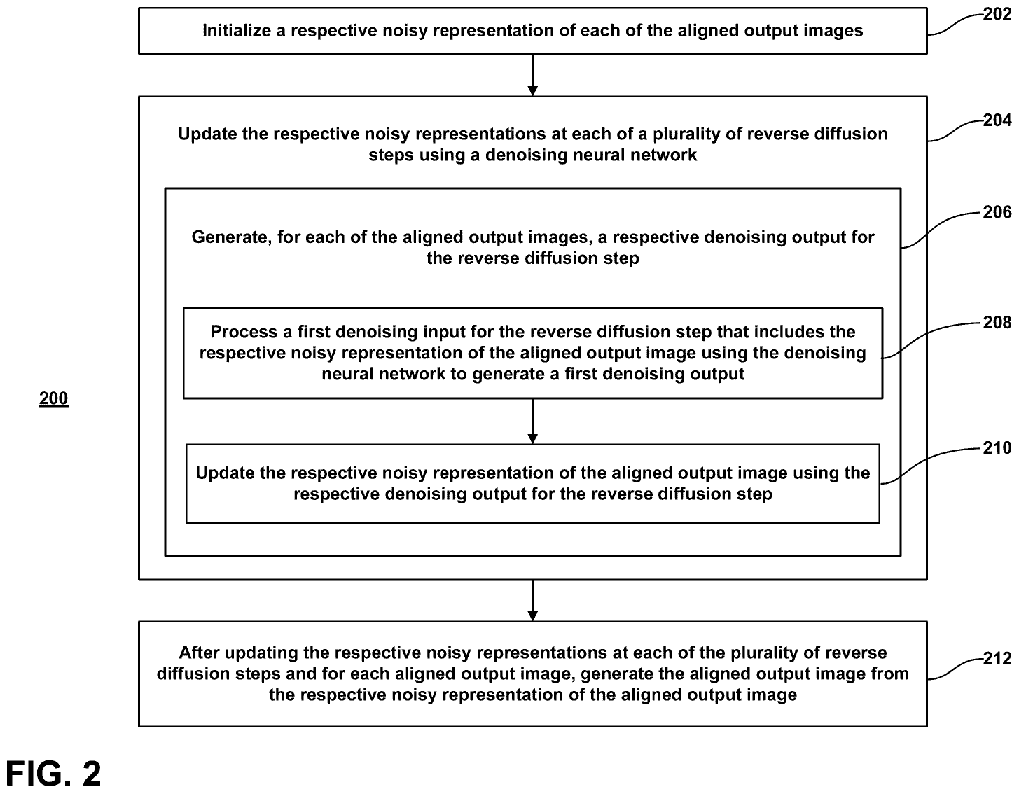

FIG. 2 is a flow diagram of an example process 200 for generating aligned output images. For convenience, the process 200 will be described as being performed by a system of one or more computers located in one or more locations. For example, an image generation system, e.g., the image generation system 100 of FIG. 1, appropriately programmed in accordance with this specification, can perform the process 200.

The aligned output images include a set of one or more reference images and a set of one or more target images. The reference image(s) generally collectively define the “style” for which the target image(s) will incorporate such that the output images are style-consistent images and are therefore “aligned”.

Some examples of styles are “retro poster style”, “minimal vector art style”, “minimal pastel color style”, “pixel art style”, “chalk art style”, and so on.

In some cases, the set of one or more reference images includes only one reference image. That is, the system generates the target image(s) according to the style of only one reference image.

In some cases, the set of one or more target images includes a plurality of target images. That is, the system generates a plurality of images that each include the style present in the reference image(s).

In some implementations, the system obtains a plurality of conditioning inputs, and the system generates each of the aligned output images conditioned on at least a corresponding one of the conditioning inputs.

The conditioning inputs can be any of a variety of types of conditioning inputs. For example, the conditioning input can be natural language text sequence, one or more images, one or more videos, audio data, a class label, and so on.

As described above, generally, the conditioning inputs each characterize one or more properties to be included in the generated output images. For example, a conditioning input that is natural language text such as “a toy airplane” can result in the system generating an output image that contains the object “a toy airplane”.

In some cases, the conditioning inputs for the reference images can include a “style description” that determines the style of the reference images. For example, the system can use a conditioning input that includes the natural language text “colorful, macro photo style” when generating a reference image, which then causes the system to generate target images to be style consistent with the “colorful, macro photo style” of the reference image.

But while the aligned images are style-consistent, their content are not the same (or need not be the same). That is, the content of the aligned output images differ (and in some cases differ according to a respective conditioning input for each image).

For example, aligned output images can all belong to the “colorful, macro photo style”, yet each image can include different content (e.g., different objects, e.g., a toy train, toy airplane, toy bicycle, toy car, and so on) which depend on different conditioning inputs for different images. As a particular example, a conditioning input for a reference image can include the natural language text “colorful, macro photo style” (e.g., the conditioning input can be “toy train colorful, macro photo style”) while the conditioning inputs for the target images can each include different content (e.g., “toy airplane colorful, macro photo style”, “toy bicycle colorful, macro photo style”, “toy car colorful, macro photo style”).

Further details of using the conditioning inputs to generate aligned output images are described below.

The system initializes a respective noisy representation of each of the aligned output images (step 202). The system generally uses sampled noise to initialize the noisy representations. In the case that the denoising neural network operates in pixel-space, each noisy representation can be sampled noise in that each dimension of the sampled noise corresponds to a pixel value. In the case that the denoising neural network operates in latent-space, each noisy representation can be sampled noise in that each dimension of the sampled noise corresponds to a value for a dimension of the latent-space representation.

The system can draw the sampled noise values from any of a variety of probability distributions, e.g., a multivariate Gaussian with isotropic covariance.

The system updates the respective noisy representations at each of a plurality of reverse diffusion steps using a denoising neural network (step 204). Generally, the system updates the noisy representations of the output images in parallel. That is, the updates to the respective noisy representations of the outputs occur in synchronized reverse diffusion steps.

In particular, for each noisy representation of an output image, the system processes a first denoising input for the reverse diffusion step that includes the respective noisy representation (and optionally the respective representation of the corresponding conditioning input) using a denoising neural network (optionally conditioned on a respective conditioning input) to generate a denoising output (from a first denoising output) that defines an estimate of a noise component of the respective noisy representation; the denoising neural network that the system uses can be any denoising neural network described above and below. The system then updates the respective noisy representation using the denoising output.

As described above, the denoising neural network can have any of a variety of neural network architectures. That is, the denoising neural network can have any appropriate architecture in any appropriate configuration that can process a denoising input to generate a denoising output, including fully connected layers, convolutional layers, recurrent layers, attention-based layers, and so on, as is appropriate. But generally, the denoising neural network the system uses to update the noisy representations includes a feature updating layer that is configured to receive an input feature representation and to update at least a portion of the input feature representation.

In some cases, the denoising neural network includes one or more additional feature updating layers. For example, the denoising neural network can have a U-ViT architecture with a plurality of transformer blocks for which each self-attention layer of these transformer blocks is replaced with a feature updating layer.

In some cases, the denoising neural network includes one or more conditioning layers that each update the input feature representation conditioned on the representation of the conditioning input. Further in some cases, the conditioning layers are cross-attention layers. For example, a denoising neural network that has a U-Net architecture with a plurality of transformer blocks in the bottleneck that each include a cross-attention layer can cross attend to the representation of the conditioning input when updating the input feature representation.

In some implementations, the denoising neural network has been trained on batches of independent training images. That is, the denoising neural network has been trained on independent, rather than aligned images, so that images in the same batch have different styles or are independently sampled with no constraint on style. Training the denoising neural network using batches of independent training images has the advantage of avoiding the requirement of training using a data set of aligned images (which can be difficult to obtain in practice).

Generally, for these implementations, the system (or another training system) previously trained the denoising neural network using a denoising objective. The denoising objective on which the system trains the initial denoising neural network using can be any of a variety of types of appropriate objectives such as a mean squared error objective (to minimize the difference between predicted estimate of a noise component of a noisy representation of an image and the true noise component), or score matching objective (to estimate the score function (defined as the gradient of the log density) of the perturbed data distribution at different noise levels).

For example, the system (or another training system) trains the denoising neural network to reverse the diffusion forward process, for example according to the following formula:

$${x}_{t} = \sqrt{{α}_{t}} {x}_{0} + \sqrt{1 - {α}_{t}} ϵ , ϵ \sim N ( 0 , I )$$

where t ∈ [0, ∞) are diffusion timesteps, xₜ is the noisy representation of an image x₀ at timestep t, and the values of variance schedule at are determined by a scheduler such that α₀ =1 and

$${lim}_{t \to ∞} {α}_{t} = 0.$$

In particular, the system trains the denoising neural network such that to generate an output image x₀ the system initializes a respective noisy representation of an output image x₀ as x_{T}˜N(0, I) (where the subscript T indicates the end point of a forward process T step diffusion process) and updates the noisy representation as the reverse process:

$${x}_{t - 1} = {μ}_{t - 1} + {σ}_{t} z , z \sim N ( 0 , I ) ,$$

where the value of σₜ is determined by the sampler and μₜ₋₁ is given by

$${μ}_{t - 1} = \frac{\sqrt{{α}_{t - 1}} {x}_{t}}{\sqrt{{α}_{t}}} + ( \sqrt{1 - 1 {α}_{t - 1}} - \frac{\sqrt{1 - {α}_{t}}}{\sqrt{{α}_{t}}} ) {ϵ}_{θ} ( {x}_{t} , t ) ,$$

where ∈_{θ}(xₜ, t) is the first denoising output of the denoising neural network parameterize by the set of trainable parameters θ and (xₜ, t) is the first denoising input that includes a representation of the output image xₜ, and a timestep t (i.e., a time input).

In some cases, a first denoising input for a noisy representation of an aligned output image also includes a representation of a conditioning input c. In such cases, the first denoising input of the denoising neural network is (xₜ, t, c) and the output of the denoising neural network is represented as ∈_{θ}(xₜ, t, c).

As part of step 204, at each of the reverse diffusion steps, the system generates, for each of the aligned output images, a respective denoising output for the reverse diffusion step (step 206).

As part of step 206, for each of the aligned output images, the system processes a first denoising input for the reverse diffusion step that includes the respective noisy representation of the aligned output image using the denoising neural network to generate a first denoising output (step 208).

In some cases, for each aligned output image, the first denoising input includes a representation of the corresponding conditioning input. That is, as described above, in some cases the system receives a plurality of conditioning inputs (a corresponding one for each aligned output image) and processes the conditioning inputs to generate respective representations of the conditioning inputs.

As described above, the conditioning input can be any of a variety of types of conditioning inputs, e.g., natural language text, image(s), video(s), audio, and so on.

The representation of the conditioning input can be any of a variety of types of representations, and typically, the representation captures the semantic context or semantic attributes of the conditioning input. For example, the representation can be a single numeric vector. As another example, the representation can be a sequence of vectors (e.g., or a sequence of embeddings).

In some cases, the conditioning input can be associated with a conditioning input encoder neural network that the system uses to generate the representation of the conditioning input.

The conditioning input encoder neural network can have any of a variety of neural network architectures. That is, the conditioning input encoder neural network can have any appropriate architecture in any appropriate configuration that can process the conditioning input to generate a representation of the conditioning input, including fully connected layers, convolutional layers, recurrent layers, attention-based layers, and so on, as is appropriate.

As part of step 208, the system will process an input feature representation that includes (i) the feature representation of the first denoising input for the target image and (ii) the respective feature representation of the respective first denoising input for each of the reference images using the feature updating layer to update the feature representation of the first denoising input for the target image. Thus, for each target image, the feature representation is updated not only using the input representation for the target image but also the feature representations for the one or more reference images. This can ensure that the generated images will have a consistent style.

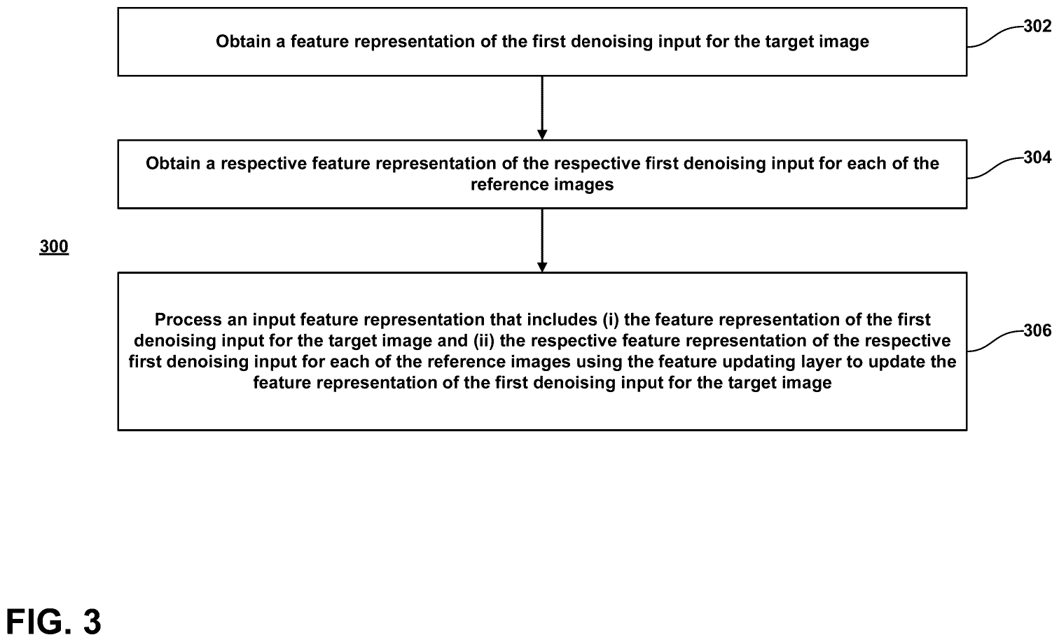

Further details of processing a first denoising input for the reverse diffusion step that includes the respective noisy representation of the aligned output image using the denoising neural network to generate a first denoising output are described below with reference to FIG. 3.

In some implementations, when the system generates, for each of the aligned output images, a respective denoising output for the reverse diffusion step, the system generates one or more additional denoising outputs for the reverse diffusion step and combines the one or more additional denoising outputs with the first denoising output through classifier-free guidance.

In other words, in some cases, for each reverse diffusion step and for each of the aligned output images the system uses classifier-free guidance. When using classifier-free guidance, the system processes the denoising input for the reverse diffusion step that includes the noisy representation of the image using the denoising neural network but not conditioned on the conditioning input to generate another denoising output. The system then combines the conditional and unconditional denoising outputs in accordance with a guidance weight for the reverse diffusion step to generate a final denoising output.

For example, the following equation

$${{ϵ}^{\sim}}_{θ} ( {x}_{t} , c ) = ( 1 + w ) {ϵ}_{θ} ( {x}_{t} , c ) - w {ϵ}_{θ} ( {x}_{t} )$$

represents how the system can use classifier-free guidance at each reverse diffusion step, where the term ∈^{˜} _{θ}(xₜ, c) denotes the final denoising output, w the guidance weight, xₜ the noisy representation of the new image, c the conditioning input, and ∈_{θ}(xₜ, c) the conditional denoising output and ∈_{θ}(xₜ) the unconditional denoising output.
Also as part of step 206, the system updates the respective noisy representation of the aligned output image using the respective denoising output for the reverse diffusion step (step 210).

For example, the system can determine an initial estimate of the final output image using the denoising output and then apply an appropriate diffusion sampler, e.g., the DDPM (Denoising Diffusion Probabilistic Model) sampler, the DDIM (Denoising Diffusion Implicit Model) sampler or another appropriate sampler, to the initial estimate of the final output image to update the current noisy representation of the output image. At the last reverse diffusion step, the system can use the initial estimate of the output image as the updated noisy representation of the output image.

For example, for a given diffusion step, when the system applies the DDPM diffusion sampler, the system can subtract the estimate of the noise component of the noisy representation of the output image from the noisy representation of the output image (e.g., an elementwise subtraction of estimated noise values of the estimated noise component from pixel values of the representation of the new image), and optionally can add back in a small amount of noise. The result is the updated noisy representation of the output image.

As another example, for a given diffusion step, when the system applies the DDIM diffusion sampler, the system can determine an initial estimate of the final representation of the output image using the noisy representation of the output image for the current diffusion step. The system then can generate the updated noisy representation of the output image using the initial estimate of the final representation of the output image and the representation of the output image of the current diffusion step. The result is the updated noisy representation of the output image.

After updating the respective noisy representations at each of the plurality of reverse diffusion steps and for each aligned output image, the system generates the aligned output image from the respective noisy representation of the aligned output image (step 212).

FIG. 3 is a flow diagram of an example process 300 for processing a first denoising input for a reverse diffusion step. For convenience, the process 300 will be described as being performed by a system of one or more computers located in one or more locations. For example, an image generation system, e.g., the image generation system 100 of FIG. 1, appropriately programmed in accordance with this specification, can perform the process 300.

The denoising neural network includes one or more feature updating layers. So, when processing any given first denoising input using the denoising neural network, for each feature updating layer of the denoising neural network, the system performs the following operations.

The system obtains a feature representation of the first denoising input for the target image (step 302).

The system obtains a respective feature representation of the respective first denoising input for each of the reference images (step 304).

For example, the feature representation can be the output of the layer preceding the feature updating layer within the denoising neural network when processing the first denoising input for the target image or for the reference images.

The system processes an input feature representation that includes (i) the feature representation of the first denoising input for the target image and (ii) the respective feature representation of the respective first denoising input for each of the reference images using the feature updating layer to update the feature representation of the first denoising input for the target image (step 306).

As described above, the feature updating layer can have any appropriate architecture in any appropriate configuration that can receive an input feature representation and update at least a portion of the input feature representation, including fully connected layers, convolutional layers, recurrent layers, attention-based layers, and so on, as is appropriate.

For example, in some cases, the feature updating layer is a self-attention layer having a set of one or more attention heads. For example, a multi-head attention layer. For such cases, the system can use the self-attention layer to have the target images attend to the reference images through an attention mechanism.

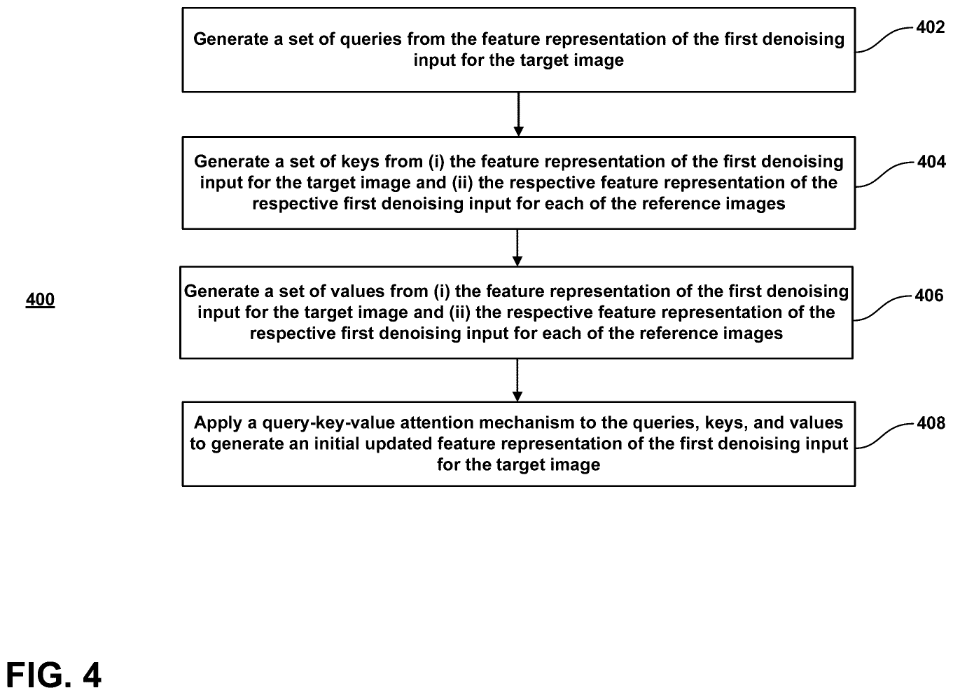

Further details of an example process for updating at least a portion of the input feature representation using a feature updating layer are described below with reference to FIG. 4.

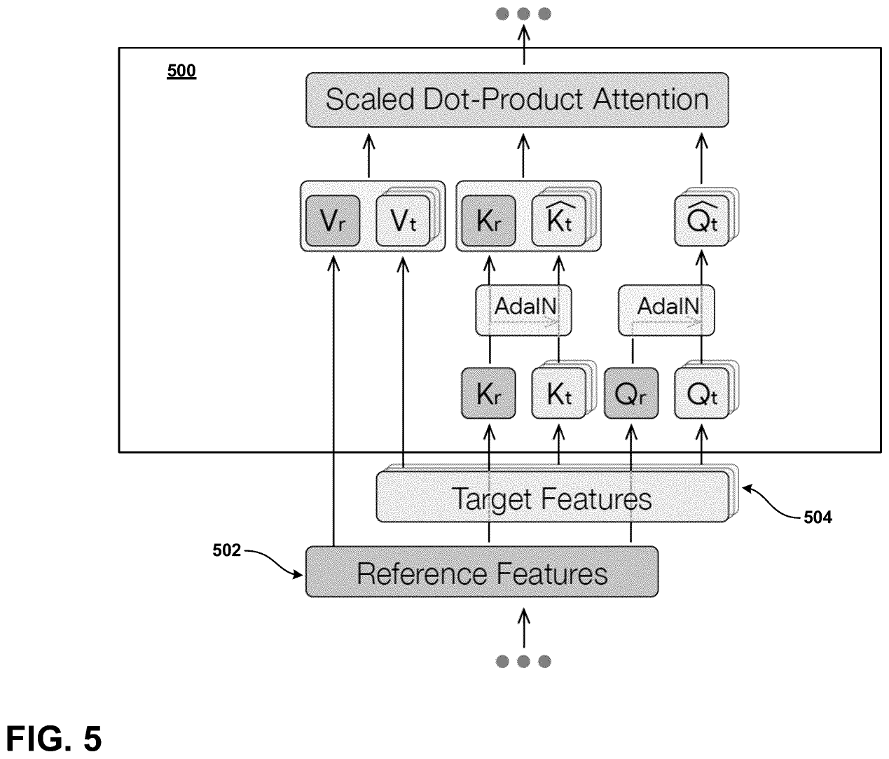

Further details of an example feature updating layer are described below with reference to FIG. 5.

In some cases, the input feature representation for the feature updating layer does not include feature representations of the first denoising inputs for any of the target images.

In some cases, the system, for the feature updating layer and for each reference image, obtains a feature representation of the first denoising input for the reference image. Then, the system processes an input feature representation that includes the feature representation of the first denoising input for the reference image through the feature updating layer to update the feature representation of the first denoising input for the reference image.

FIG. 4 is a flow diagram of an example process 400 for updating at least a portion of an input feature representation using a feature updating layer. For convenience, the process 400 will be described as being performed by a system of one or more computers located in one or more locations. For example, an image generation system, e.g., the image generation system 100 of FIG. 1, appropriately programmed in accordance with this specification, can perform the process 400.

In particular, process 400 is an example of the system processing, for each of the one or more attention heads of a feature updating layer that is a self-attention layer with one or more attention heads, an input feature representation that includes (i) the feature representation of the first denoising input for the target image and (ii) the respective feature representation of the respective first denoising input for each of the reference images using the feature updating layer to update the feature representation of the first denoising input for the target image and includes steps 402-408 below.

An attention mechanism will generally include computing queries Q ∈ R^{n×d}^{ₖ} (i.e., n query vectors of dimensionality dₖ), keys K ∈ R^{m×d}^{ₖ} (i.e., m key vectors of dimensionality dₖ), and values V ∈ R^{m×d}^{ᵥ} (i.e., m value vectors of dimensionality dₖ) for an n length input sequence and a m length memory sequence using learned linear projections. For the case of self-attention, the input sequence and the memory sequence are the same and the attention output can be computed as function Attention(Q, K, V) defined by

$$Attention ( Q , K , V ) := soft max ( \frac{{QK}^{T}}{\sqrt{{d}_{k}}} ) V$$

for sets of queries Q, keys K, and values V.

In some cases, for each aligned output image, the feature representation of the first denoising input for the aligned output image includes a plurality of feature vectors. So, for example, the system can identify the feature representation of the first denoising input for the image Iᵢ (where subscript i denotes an index value to identify the corresponding image Iᵢ among the set of aligned output images I₁. . . Iₙ) as ϕᵢ ∈ R^{n×d}^{ₓ} (i.e., n feature vectors of dimensionality dₓ).

The system generates a set of queries from the feature representation of the first denoising input for the target image (step 402).

In some cases, the set of queries includes a respective query vector for each feature vector in the feature representation of the first denoising input for the target image.

For example, if the feature representation of the first denoising input for the target image includes n feature vectors, the system can generate the set of queries Qₜ ∈ R^{n×d}^{ₖ} (i.e., n query vectors of dimensionality dₖ) for the feature representation of the first denoising input for the target image using a learned linear projection, where the subscript t of Q in this example refers to the image index of the target image.

The system generates a set of keys from (i) the feature representation of the first denoising input for the target image and (ii) the respective feature representation of the respective first denoising input for each of the reference images (step 404).

In some cases, the set of keys includes a respective key vector for each feature vector in (i) the feature representation of the first denoising input for the target image and (ii) the respective feature representation of the respective first denoising input for each of the reference images.

For example, for a feature representation ϕᵢ of the first denoising input for the image Iᵢ that includes m feature vectors, the system can generate the set of keys Kᵢ ∈ R^{m×d}^{ₖ} (i.e., m key vectors of dimensionality dₖ) using a learned linear projection, where the subscript of K is the image index. Then, if ϕ₁ . . . ϕₙ are the feature representations of the first denoising input for the target image and the respective feature representation of the first denoising input for each of the reference images, then the system can generate the set of keys as K_{1 . . . n}=[K₁ K₂···Kₙ]^{T}.

The system generates a set of values from (i) the feature representation of the first denoising input for the target image and (ii) the respective feature representation of the respective first denoising input for each of the reference images (step 406).

In some cases, the set of values includes a respective value vector for each feature vector in (i) the feature representation of the first denoising input for the target image and (ii) the respective feature representation of the respective first denoising input for each of the reference images.

For example, for a feature representation ϕᵢ of the first denoising input for the image Iᵢ that includes m feature vectors, the system can generate the set of values Vᵢ ∈ R^{m×d}^{ᵥ} (i.e., m value vectors of dimensionality dₖ) using a learned linear projection, where the subscript of V is the image index i. Then, if ϕ₁ . . . ϕₙ are the feature representation of the first denoising input for the target image and the respective feature representations of the first denoising input for each of the reference images, the system can generate the set of values can as V_{1 . . . n}=[V₁ V₂···Vₙ]^{T}.

The system applies a query-key-value attention mechanism to the queries, keys, and values to generate an initial updated feature representation of the first denoising input for the target image (step 408).

For example, the system applies a query-key-value attention mechanism to the queries, keys, and values as Attention(Qₜ, K_{1 . . . n}, V_{1 . . . n}) with terms as defined above to generate an attention output that is the initial updated feature representation of the first denoising input for the target image.

In some implementations, to apply the query-key-value attention mechanism to the queries, keys, and values to generate an initial updated feature representation of the first denoising input for the target image, the system generates a normalized set of queries for the target image by normalizing the query vectors using a set of queries generated from the feature representation of the first denoising input for the reference image. Normalizing the queries and keys for each of the target images as described improves the style alignment of each target image with the reference image because the computed attention scores between queries and keys reflect similarity more (as opposed to reflecting predominately magnitude differences that would occur without normalization).

For example, to normalize the query vectors, the system can apply an adaptive instance normalization operation to the query vectors and the set of queries generated from the feature representation of the first denoising input for the reference image. That is, the system can use the adaptive normalization operator AdaIN (x, y) as described in arXiv:1703.06868 to generate a normalized set of queries for the target image. In particular, AdaIN (x, y) is defined as

$$AdaIN ( x , y ) := σ ( y ) ( \frac{x - μ ( x )}{σ ( x )} ) + μ ( y )$$

where terms μ(x), σ(x) are the dimension-wise mean and the standard deviation of an input x and μ(y) is the dimension-wise mean of an input y. So the system can compute the normalized query vectors Q\hat{ }ₜ (where the subscript t of Q\hat{ }ₜ refers to the target image index and the hat operator indicates of Q\hat{ }ₜ refers to the fact that it is the normalized queries of Qₜ) as the equation

$${{Q}^{\hat{}}}_{t} = AdaIN ( {Q}_{t} , {Q}_{r} )$$

where Qᵣ denotes the set of queries generated from the feature representation of the first denoising input for the reference image.

Furthermore, in some of the above described implementations, the system generates a normalized set of keys, which includes normalizing the respective key vectors for the feature vectors in the feature representation of the first denoising input for the target image using the respective key vectors for the feature vectors in the feature representation of the first denoising input for the reference image.

For example, to normalize the respective key vectors for the feature vectors in the feature representation of the first denoising input for the target image, the system can apply an adaptive instance normalization operation to the respective key vectors for the feature vectors in the feature representation of the first denoising input for the target image and the respective key vectors for the feature vectors in the feature representation of the first denoising input for the reference image. That is, the system can use the AdaIN (x, y) operation described above to generate a normalized set of key vectors as

$${{K}^{\hat{}}}_{t} = AdaIN ( {K}_{t} , {K}_{r} )$$

where Kₜ is the set of keys for the target image and Kᵣ is the set of keys for the reference image. So K\hat{ }ₜ refers to the fact that it is the normalized queries of Kₜ.

Additionally, in some of the above described implementations, the system applies the query-key-value attention mechanism to the normalized set of queries, normalized set of keys, and the set of values to generate the initial updated feature representation of the first denoising input for the target image.

For example, the system can generate the normalized set of queries Q\hat{ }ₜ as described above, the set of normalized set of keys K\hat{ }ₜ for the target as described above, the set of values Vᵣ for a reference image, and the set of values Vₜ for the target image to apply the query-key-value attention mechanism as

$$Attention ( {Q}_{t}^{⋀} , {K}_{rt}^{T} , {V}_{rt} )$$

where Kᵣₜ=[Kᵣ K\hat{ }ₜ]and Vᵣₜ=[VᵣVₜ].

After completing steps 402-408 for the one or more attention heads, in some cases, when there is more than one attention head, the system combines the initial updated feature representations for each of the attention heads to update the feature representation of the first denoising input for the target image.

For example, the system can concatenate the initial updated feature representation for each of the attention heads and apply a learned linear projection to the concatenation to generate an updated feature representation of the first denoising input for the target image. The equation Concat(head₁, . . . , headₕ)W represents an example how the system can combine the initial updated feature representations to update the feature representation, where there are h attention heads, headᵢ represents the initial updated feature representation for an attention head indexed as i, Concat(·) is the concatenation operation, and Concat(head₁, . . . , headₕ)W represents a learned linear projection.

FIG. 5 shows an example feature updating layer 500. The system can use the example feature updating layer 500 to update at least a portion of each input feature representation in a set of input feature representations in parallel using the feature updating layer 500.

An input feature representation includes (i) the respective feature representation of the first denoising input for a reference image 502 and (ii) the respective feature representation of the first denoising input for a target image. The set of input feature representations includes an input feature representation for every target image. Each block labeled “Target Features” of the stacked blocks for 504 represents a respective feature representation for a target image.

The system generates a set of values Vᵣ, a set of keys Kᵣ, and a set of queries Qᵣ from the feature representation of the reference image 502. For example, the system can use learned linear projections to generate Vᵣ, Kᵣ, and Qᵣ as described above.

For every input feature representation in the set of input feature representations, the system generates a set of values Vₜ, a set of keys Kₜ, and a set of queries Qₜ from the respective feature representation for the respective target image.

For every input feature representation in the set of input feature representations, the system generates a set of normalized keys [symbol] and normalized queries [symbol] . For example 500, the system uses the adaptive normalization operator AdaIN to generate [symbol] and [symbol] as described above. That is, the system performs K\hat{ }ₜ=AdaIN(Kₜ, Kᵣ) and Q\hat{ }ₜ=AdaIN(Qₜ, Qᵣ) for every reference image and target image pair.

For every input feature representation in the set of input feature representations, the system then applies the query-key-value attention mechanism using the normalized sets of queries and keys for the target image, the values of the reference image and the respective target image, and the keys of the reference image. That is, the system applies (as described above) the query-key-value attention mechanism

$$Attention ( {Q}_{t}^{⋀} , {K}_{rt}^{T} , {V}_{rt} )$$

where Kᵣₜ=[Kᵣ K\hat{ }ₜ] and Vᵣₜ=[Vᵣ Vₜ] to generate an initial updated feature representation of the first denoising input for the target image.

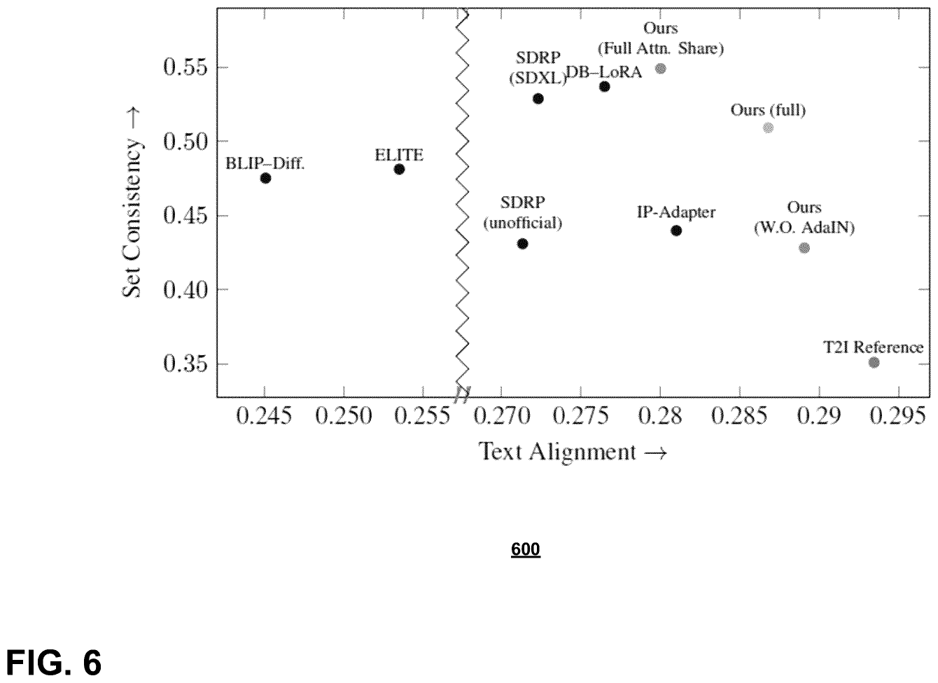

FIG. 6 is an example 600 of the performance of the described techniques.

In particular, example 600 is a chart that shows the performance of various techniques in terms of “text alignment” represented on the x-axis and “set consistency” represented on the y-axis. The “text alignment” refers to a measurement of how well the content of the generated aligned output images reflect the conditioning input (i.e., CLIP cosine similarity between the alignment output images and a conditioning input that is the text description of the object). The “set consistency” refers to a measurement of how consistent the style of each of the generated aligned output images are (i.e., the pairwise average cosine similarity between DINO VIT-B/8 embeddings of the generated images in each set). The points labeled as “Ours” with additional parenthetical labels (i.e., “Full Attn. Share”, “W.O. AdaIN”, “full”) are the described techniques, while the points not labeled as “Ours” (i.e., “DB-LoRA”, “SDRP”, “IP-Adapter”, “SDRP”, “ELITE”, “BLIP-Diff”) are other techniques.

For example 600, the closer points are to the top-right corner of the chart the better the overall performance (i.e., generally a balance of the set consistency and text alignment becomes better).

Example 600 shows that the variants of the described techniques outperform other techniques. The first variant (i.e., “Ours (Full Attn. Share)” uses “full attention sharing” (i.e., updates the feature representation of the target image using an updating feature layer that includes the use of an attention mechanism between the feature representations of the target image and all images in the set of aligned output images). The second variant (i.e., “Ours (W.O. AdaIN)”) omits the AdaIN operation (i.e., does not normalize target image queries and target image keys as described above). The third variant (i.e., “Ours (full)”) does include the use of the AdaIN operation to normalize target image queries and target image keys as described above and uses “partial attention sharing” (i.e., updates the feature representation of the target image using an updating feature layer that includes the use of an attention mechanism between the target image and reference image in the set of aligned output images).

Relative to the third variant (“full” variant), the first variant (“Full Attn. Share” variant) results in higher style consistency and lower text alignment. As a result of using “full attention sharing” instead of “partial attention sharing” the set consistency increases at the expense of text alignment, demonstrating how “partial attention sharing” contributes to enabling the content of the generated aligned output images to reflect the conditioning input.

Moreover, relative to the third variant, the second variant (“W.O. AdaIN”) has lower set consistency but higher improved text alignment. As a result of using the AdaIN operator to normalize target image queries and target image keys, the text alignment improves at the cost of set consistency, indicating that normalization of the target image queries and target image keys improves text alignment.

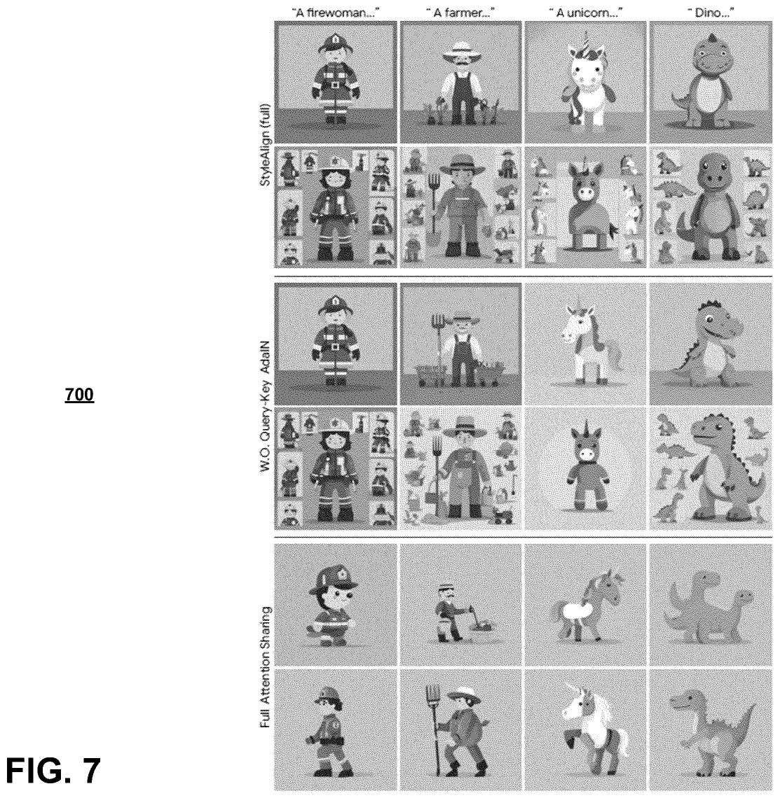

FIG. 7 is an example 700 of the performance of the described techniques.

In particular, example 700 shows generated aligned output images of the described techniques using the variants of the described techniques discussed above with reference to FIG. 6.

Each pair of rows corresponds to a specific variant of the described techniques introduced above with reference to FIG. 6, and each row in a pair uses different seeds (i.e., different initialized noisy representations of aligned output images at the beginning the image generation process). Additionally, each pair of rows shows two sets of images generated by the same set of conditioning inputs (i.e., natural language text “A firewoman”, “A farmer”, “A unicorn”, and “Dino” followed by “ . . . in minimal flat design illustration” using different variants of the described techniques. The top pair of rows corresponds to the variant “Ours (full)” described above (labeled here on the y-axis as “StyleAligned (full)”, the middle pair of rows corresponds to the variant “Ours (W.O. AdaIN)” described above (labeled here on the y-axis as “W.O. Query-key AdaIN”), and the bottom pair of rows corresponds to the variant “Ours (Full Attn. Share)”.

Sharing the self-attention between all images in the set (bottom) results with some diversity loss (style collapse across many seeds) and content leakage within each set (colors from one image leak to another). Disabling the queries—keys AdaIN operation results with less consistent image sets compared to our full method (top) which keeps on both diversity between different sets and consistency within each set. These findings are a visual qualitative conclusion to findings of FIG. 6 described above.

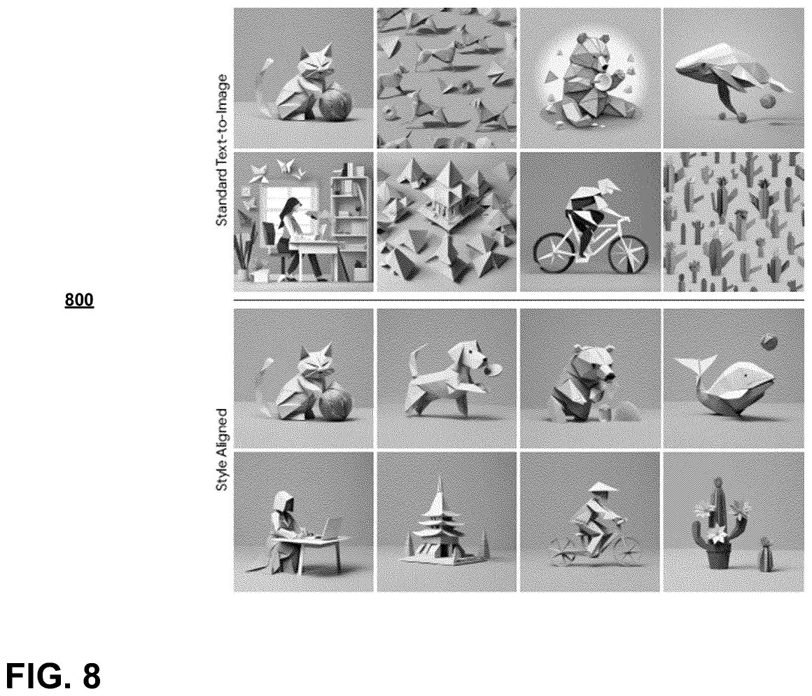

FIG. 8 is an example 800 of the performance of the described techniques.

In particular, example 800 shows generated aligned output images of the described techniques (i.e., the bottom pair of rows labeled “style aligned”) compared to those generated using a standard technique (i.e., the top pair or rows labeled “standard text-to-image”. Both techniques generate a set of images conditioned on a set conditioning inputs (i.e., natural language text descriptor of an object followed by “minimal origami”). But the text-to-image generation (top) results with an unaligned image set while the described techniques (bottom) can generate variety of style aligned content. So, while proficient in aligning with the textual description of the style, “standard text-to-image” techniques often create images that diverge significantly in their interpretations of the same stylistic descriptor, as depicted in example 800. This significant divergence is due to each image being “unaware” of the exact appearance of other images in the set during the generation process. In contrast, each image is “aware” of the appearance of other images through the described techniques' using, for each target image, the feature updating layer to process an input feature representation to update the feature representation of the first denoising input for the target image.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine- readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are correspond toed in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes correspond toed in the accompanying figures do not necessarily require the particular order shown, or sequential order, to achieve desirable results. In some cases, multitasking and parallel processing may be advantageous.

What is claimed is:

1. A method performed by one or more computers and for generating a plurality of aligned output images, the aligned output images comprising a set of one or more reference images and a set of one or more target images, the method comprising:
initializing a respective noisy representation of each of the aligned output images;
updating the respective noisy representations at each of a plurality of reverse diffusion steps using a denoising neural network, wherein the denoising neural network comprises a feature updating layer that is configured to receive an input feature representation and to update at least a portion of the input feature representation, and wherein the updating comprises, at each of the reverse diffusion steps:
generating, for each of the aligned output images, a respective denoising output for the reverse diffusion step, the generating comprising, for each of the aligned output images:
processing a first denoising input for the reverse diffusion step that comprises the respective noisy representation of the aligned output image using the denoising neural network to generate a first denoising output, wherein processing the first denoising input for the reverse diffusion step comprises, for the feature updating layer and for each target image:
obtaining a feature representation of the first denoising input for the target image;
obtaining a respective feature representation of the respective first denoising input for each of the reference images; and
processing an input feature representation comprising (i) the feature representation of the first denoising input for the target image and (ii) the respective feature representation of the respective first denoising input for each of the reference images using the feature updating layer to update the feature representation of the first denoising input for the target image; and
updating the respective noisy representation of the aligned output image using the respective denoising output for the reverse diffusion step; and
after updating the respective noisy representations at each of the plurality of reverse diffusion steps and for each aligned output image, generating the aligned output image from the respective noisy representation of the aligned output image.

2. The method of claim 1, further comprising obtaining a plurality of conditioning inputs, wherein each of the aligned output images is conditioned on at least a corresponding one of the conditioning inputs.

3. The method of claim 2, wherein, for each aligned output image, the first denoising input comprises a representation of the corresponding conditioning input.

4. The method of claim 3, wherein generating, for each of the aligned output images, a respective denoising output for the reverse diffusion step, comprises generating one or more additional denoising outputs for the reverse diffusion step and combining the one or more additional denoising outputs with the first denoising output through classifier-free guidance.

5. The method of claim 1, wherein the set of one or more reference images includes only one reference image.

6. The method of claim 1, wherein the set of one or more target images includes a plurality of target images.

7. The method of claim 1, wherein, for each target image, the input feature representation for the feature updating layer does not include feature representations of the first denoising inputs for any of the other target images.

8. The method of claim 1, wherein processing the first denoising input for the reverse diffusion step further comprises, for the feature updating layer and for each reference image:
obtaining a feature representation of the first denoising input for the reference image; and
processing an input feature representation comprising the feature representation of the first denoising input for the reference image through the feature updating layer to update the feature representation of the first denoising input for the reference image.

9. The method of claim 1, wherein the feature updating layer is a self-attention layer having a set of one or more attention heads.

10. The method of claim 9, wherein processing an input feature representation comprising (i) the feature representation of the first denoising input for the target image and (ii) the respective feature representation of the respective first denoising input for each of the reference images using the feature updating layer to update the feature representation of the first denoising input for the target image comprises, for each of the one or more attention heads:
generating a set of queries from the feature representation of the first denoising input for the target image;
generating a set of keys from (i) the feature representation of the first denoising input for the target image and (ii) the respective feature representation of the respective first denoising input for each of the reference images;
generating a set of values from (i) the feature representation of the first denoising input for the target image and (ii) the respective feature representation of the respective first denoising input for each of the reference images; and
applying a query-key-value attention mechanism to the queries, keys, and values to generate an initial updated feature representation of the first denoising input for the target image.

11. The method of claim 10, wherein the set of one or more attention heads includes a plurality of attention heads and wherein processing an input feature representation comprising (i) the feature representation of the first denoising input for the target image and (ii) the respective feature representation of the respective first denoising input for each of the reference images using the feature updating layer to update the feature representation of the first denoising input for the target image further comprises:
combining the initial updated feature representations for each of the attention heads to update the feature representation of the first denoising input for the target image.

12. The method of claim 10, wherein:
for each aligned output image, the feature representation of the first denoising input for the aligned output image comprises a plurality of feature vectors;
the set of queries comprises a respective query vector for each feature vector in the feature representation of the first denoising input for the target image;
the set of keys comprises a respective key vector for each feature vector in (i) the feature representation of the first denoising input for the target image and (ii) the respective feature representation of the respective first denoising input for each of the reference images; and
the set of values comprises a respective value vector for each feature vector in (i) the feature representation of the first denoising input for the target image and (ii) the respective feature representation of the respective first denoising input for each of the reference images.

13. The method of claim 12, wherein the set of one or more reference images includes only one reference image, and wherein applying a query-key-value attention mechanism to the queries, keys, and values to generate an initial updated feature representation of the first denoising input for the target image comprises:
generating a normalized set of queries for the target image by normalizing the query vectors using a set of queries generated from the feature representation of the first denoising input for the reference image;
generating a normalized set of keys, comprising normalizing the respective key vectors for the feature vectors in the feature representation of the first denoising input for the target image using the respective key vectors for the feature vectors in the feature representation of the first denoising input for the reference image; and
applying the query-key-value attention mechanism to the normalized set of queries, normalized set of keys, and the set of values to generate the initial updated feature representation of the first denoising input for the target image.

14. The method of claim 13, wherein normalizing the query vectors comprises applying an adaptive instance normalization operation to the query vectors and the set of queries generated from the feature representation of the first denoising input for the reference image.

15. The method of claim 13, wherein normalizing the respective key vectors for the feature vectors in the feature representation of the first denoising input for the target image comprises applying an adaptive instance normalization operation to the respective key vectors for the feature vectors in the feature representation of the first denoising input for the target image and the respective key vectors for the feature vectors in the feature representation of the first denoising input for the reference image.

16. The method of claim 1, wherein the denoising neural network comprises one or more additional feature updating layers.

17. The method of claim 1, wherein, for each aligned output image, the first denoising input comprises a representation of the corresponding conditioning input, and wherein the denoising neural network comprises one or more conditioning layers that each update the input feature representation conditioned on the representation of the conditioning input.

18. The method of claim 17, wherein the conditioning layers are cross-attention layers.

19. A system comprising one or more computers and one or more storage devices storing instructions that are operable, when executed by the one or more computers, to cause the one or more computers to perform operations for generating a plurality of aligned output images, the aligned output images comprising a set of one or more reference images and a set of one or more target images, the operations comprising:
initializing a respective noisy representation of each of the aligned output images;
updating the respective noisy representations at each of a plurality of reverse diffusion steps using a denoising neural network, wherein the denoising neural network comprises a feature updating layer that is configured to receive an input feature representation and to update at least a portion of the input feature representation, and wherein the updating comprises, at each of the reverse diffusion steps:
generating, for each of the aligned output images, a respective denoising output for the reverse diffusion step, the generating comprising, for each of the aligned output images:
processing a first denoising input for the reverse diffusion step that comprises the respective noisy representation of the aligned output image using the denoising neural network to generate a first denoising output, wherein processing the first denoising input for the reverse diffusion step comprises, for the feature updating layer and for each target image:
obtaining a feature representation of the first denoising input for the target image;
obtaining a respective feature representation of the respective first denoising input for each of the reference images; and
processing an input feature representation comprising (i) the feature representation of the first denoising input for the target image and (ii) the respective feature representation of the respective first denoising input for each of the reference images using the feature updating layer to update the feature representation of the first denoising input for the target image; and
updating the respective noisy representation of the aligned output image using the respective denoising output for the reverse diffusion step; and
after updating the respective noisy representations at each of the plurality of reverse diffusion steps and for each aligned output image, generating the aligned output image from the respective noisy representation of the aligned output image.

20. One or more computer storage media encoded with instructions that, when executed by one or more computers, cause the one or more computers to perform operations for generating a plurality of aligned output images, the aligned output images comprising a set of one or more reference images and a set of one or more target images, the operations comprising:
initializing a respective noisy representation of each of the aligned output images;
updating the respective noisy representations at each of a plurality of reverse diffusion steps using a denoising neural network, wherein the denoising neural network comprises a feature updating layer that is configured to receive an input feature representation and to update at least a portion of the input feature representation, and wherein the updating comprises, at each of the reverse diffusion steps:
generating, for each of the aligned output images, a respective denoising output for the reverse diffusion step, the generating comprising, for each of the aligned output images:
processing a first denoising input for the reverse diffusion step that comprises the respective noisy representation of the aligned output image using the denoising neural network to generate a first denoising output, wherein processing the first denoising input for the reverse diffusion step comprises, for the feature updating layer and for each target image:
obtaining a feature representation of the first denoising input for the target image;
obtaining a respective feature representation of the respective first denoising input for each of the reference images; and
processing an input feature representation comprising (i) the feature representation of the first denoising input for the target image and (ii) the respective feature representation of the respective first denoising input for each of the reference images using the feature updating layer to update the feature representation of the first denoising input for the target image; and
updating the respective noisy representation of the aligned output image using the respective denoising output for the reverse diffusion step; and
after updating the respective noisy representations at each of the plurality of reverse diffusion steps and for each aligned output image, generating the aligned output image from the respective noisy representation of the aligned output image.
